(19) United States
(12) Patent Application Publication
(10) Pub. No.: US 2015/0327960 A1
(43) Pub. Date: Nov. 19, 2015

(54) DENTAL IMPLANT REPORTING TOOL

(71) Applicant: Zimmer Dental, Inc., Carlsbad, CA (US)

(72) Inventors: Scott Zielinski, Carlsbad, CA (US); Elizabeth Audiffred, Carlsbad, CA (US); John Zacharia, San Diego, CA (US); Leonard Conner, Irvine, CA (US); Elizabeth Olsen, Oceanside, CA (US)

(21) Appl. No.: 14/698,008

(22) Filed: Apr. 28, 2015

Related U.S. Application Data
(60) Provisional application No. 62/000,100, filed on May 19, 2014.

(51) Int. Cl. A61C 13/00; A61C 13/34; A61C 8/00

(52) U.S. Cl. CPC A61C 13/0004; A61C 8/008; A61C 13/34

(57) ABSTRACT

Techniques described include, for example, a computer implemented method of recording dental implant information that includes displaying a dental implant surgical reporting template on an electronic device having a display and a user interface, receiving, using the user interface, first information corresponding to a dental implant surgery, accessing a database to retrieve data using at least some of the received first information, populating at least one field in the displayed template with the retrieved data, and generating a report for a dental restoration specialist, the report including at least some of the received first information and the retrieved data.

### CLAIM OF PRIORITY

This application claims the benefit of U.S. Provisional Application No. 62/000,100, titled “Dental Implant Reporting Tool” to Zielinski et al., and filed on May 19, 2014, the entire content of which being incorporated herein by reference.

### TECHNICAL FIELD

This disclosure relates generally to dental prosthetics.

### BACKGROUND

Dental implants are commonly used as anchoring members in prosthodontic restorations to provide prosthetic teeth at one or more edentulous sites in a patient's dentition at which the patient's original natural teeth have been lost or damaged.

Typically, known implant systems include a dental implant made from a suitable biocompatible material, such as titanium. The dental implant is typically threaded into a bore which is drilled into the patient's mandible or maxilla at the edentulous site. The implant provides an anchoring member for a dental abutment, which in turn provides an interface between the implant and a dental restoration. The restoration is typically a porcelain crown fashioned according to known methods to replicate the shape of the tooth being replaced.

Many current dental implant surgeries are performed in two stages. In the initial or first stage, a dental implant surgeon makes an incision in the patient's gingiva at an edentulous site, and a bore is drilled into the patient's mandible or maxilla at the edentulous site, followed by threading or impacting a dental implant into the bore using a suitable driver. Thereafter, a cap is fitted onto the implant to close the abutment coupling structure of the implant, and the gingiva is sutured over the implant. Over a period of several months, the patient's jaw bone grows around the implant to securely anchor the implant in the surrounding bone, a process known as osseointegration.

In a second stage of the procedure following osseointegration, a restoration specialist, e.g., a dentist, surgically reopens the gingiva at the implant site and secures an abutment and optionally, a temporary prosthesis or temporary healing member, to the implant. Then, a suitable permanent prosthesis or crown is fashioned, such as from one or more impressions taken of the abutment and the surrounding gingival tissue and dentition. In the final stage, the temporary prosthesis or healing member is removed and replaced with the permanent prosthesis, which is attached to the abutment with cement or with a fastener, for example.

### OVERVIEW

In general, this disclosure describes a dental implant surgical reporting tool that may allow a dental implant surgeon or clinician to quickly and accurately assemble information regarding the dental implant surgery, e.g., a tooth number, a diameter of the implant, recommended prosthetics, patient details, etc., and generate a final report that may be sent to a restoration specialist, e.g., dentist. The techniques described in this disclosure are in contrast to hand written paper reports, for example, that may inadvertently include inaccurate information, e.g., implant diameters that are not possible based on the tooth number being repaired. Rather, the techniques of this disclosure may reduce or eliminate reporting errors by, among other things, automatically filtering out information that is not applicable based on inputted user information before presenting the information to the dental implant surgeon or clinician. In this manner, reporting errors may be reduced and the reporting process may be streamlined.

Example 1 includes subject matter for recording dental implant information (such as a method, means for performing acts, machine readable medium including instructions that when performed by a machine cause the machine to performs acts, or an apparatus configured to perform) comprising: displaying a dental implant surgical reporting template on an electronic device having a display and a user interface; receiving, using the user interface, first information corresponding to a dental implant surgery; accessing a database to retrieve data using at least some of the received first information; populating at least one field in the displayed template with the retrieved data; and generating a report for a dental restoration specialist, the report including at least some of the received first information and the retrieved data.

In Example 2, the subject matter of Example 1 may optionally include, wherein after populating the at least one field in the template with the retrieved data: receiving, using the user interface, second information based on the retrieved data, wherein generating a report for a dental restoration specialist includes: generating the report for the dental restoration specialist, the report including at least some of the received first information, the received second information, and the retrieved data.

In Example 3, the subject matter of any one or more of Examples 1 to 2 may include, wherein the retrieved data includes a plurality of dental prosthetics, and wherein the second information includes a user selection of one of the plurality of dental prosthetics.

In Example 4, the subject matter of any one or more of Examples 1 to 3 may include, wherein displaying the dental implant surgical reporting template includes: displaying a graphical representation of a set of teeth; wherein receiving, using the user interface, first information corresponding to a dental implant surgery includes: receiving, using the user interface, a selection of one or more teeth in the set of teeth corresponding to a dental implant surgery.

In Example 5, the subject matter of any one or more of Examples 1 to 4 may include, wherein the first information includes an implant diameter.

In Example 6, the subject matter of any one or more of Examples 1 to 5 may include, wherein the retrieved data includes a platform diameter.

In Example 7, the subject matter of any one or more of Examples 1 to 6 may include, wherein the first information includes information regarding a healing collar, and wherein populating at least one field in the displayed template with the retrieved data includes displaying a plurality of types of healing collars.

In Example 8, the subject matter of any one or more of Examples 1 to 7 may include, wherein the first information includes information regarding a cover screw.

In Example 9, the subject matter of any one or more of Examples 1 to 8 may include, wherein the database is stored on the electronic device.

In Example 10, the subject matter of any one or more of Examples 1 to 9 may include, receiving, using the user interface, at least one of a patient name, a surgical doctor name, a dental restoration specialist name, and a surgery date.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 is a perspective exploded view of an example abutment and a dental implant.

FIG. 2 is a block diagram illustrating various example components of an electronic device configured to run the dental implant reporting tool of this disclosure.

FIGS. 3-9 are screenshots of various example portions of a template of the dental implant reporting tool.

FIG. 10 is a block diagram of a machine in the example form of a computer system within which instructions may be executed for causing the machine to perform any one or more of the methodologies discussed in this disclosure.

FIG. 11 is flow diagram of an example method of recording dental implant information, in accordance with this disclosure.

### DETAILED DESCRIPTION

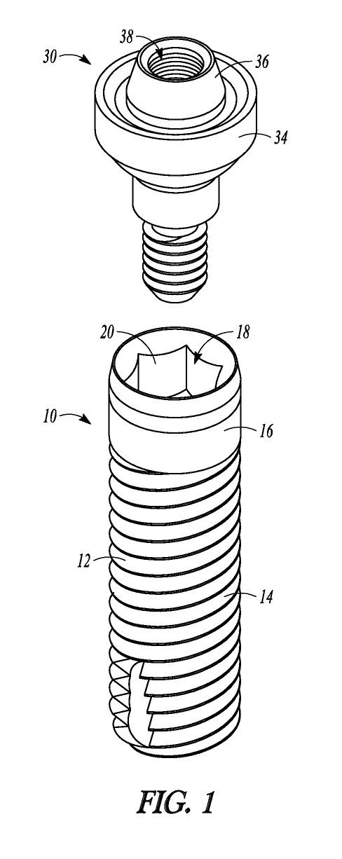

FIG. 1 illustrates an abutment configured to be secured to a dental implant for use in a dental restoration. The implant and abutments shown in FIG. 1 are merely examples and are provided for background purposes only. The implant 10 may be generally cylindrical in shape, or tapered in shape, for example. The dental implant 10 may be a unitary member formed of a biocompatible material, such as titanium or stainless steel, for example. The implant 10 may include a head portion 16 at a coronal or proximal end of the implant 10 and a stem portion 12 extending from the head portion 16 to an apical or distal end of the implant 10. The stem portion 12 may include external threading 14 or other engagement features such as a porous metal scaffold for engagement with a bone during implantation of the dental implant 10.

The implant 10 may include a bore 18 extending into the implant from the coronal or proximal end of the implant 10. The central axis of the bore 18 may be co-axial with the central longitudinal axis of the implant 10. The proximal end of the bore 18 may be configured to receive a driver for rotationally inserting the implant 10 in a bone. For example, the proximal end of the bore 18 may include an internal hex 20 for receiving a hex driver therein. The implant 10 may also include an abutment interface structure for attaching an abutment to the implant 10. In some instances, the internal hex 20 may be provided as at least one component of the abutment interface structure. Although the abutment interface structure between the implant 10 and an abutment is shown as an internal hex 20 within the implant 10 which receives an external hex of an abutment as described below, in some instances the arrangement may be reversed. Also, other types of implant/abutment interfaces are contemplated, such as splines, octagons, lobes, torx, other geometric shapes, and other engaging configurations.

The abutment interface structure may additionally or alternatively include an internally threaded portion of the bore 18 for threadably engaging a component of an abutment to attach an abutment to the implant 10.

The abutment 30 may be configured to be secured to the implant 10. For example, the abutment 30 may include an externally threaded portion 32 configured to mate with and threadably engage the internally threaded portion (not depicted) of the bore 18. The abutment 30, which may be a unitary member, may also include a cuff 34 and a cone portion 36 having a threaded bore 38 extending therein. The abutment 30 may be configured such that the central longitudinal axis of the abutment 30, which is the central longitudinal axis of the externally threaded portion 32 and the threaded bore 38, is co-axial with the central longitudinal axis of the implant 10. A restoration specialist may attach a prosthetic (not depicted), e.g., crown, to the abutment via threaded bore 38 to complete the restoration procedure.

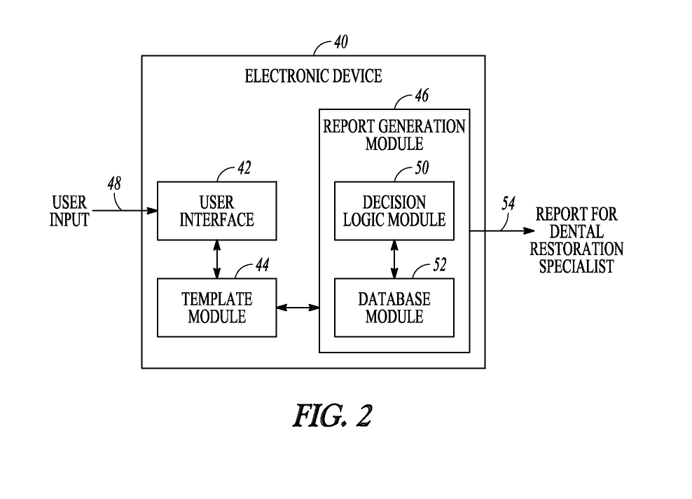

FIG. 2 is a block diagram illustrating various example components of an electronic device 40 configured to run the dental implant reporting tool of this disclosure. The electronic device 40 may include a user interface 42, a template module 44, and a dental implant report generation module 46. In one example, the electronic device 40 may be a tablet computer and the user interface may be a touchscreen display. In other examples, the electronic device 40 may be a laptop or desktop computer and the user interface 42 may be a touchscreen display and/or include a keyboard and mouse.

The template module 44 may be configured to receive user input information 48 via the user interface 42. For example, the template module 44 may receive input information corresponding to a dental implant surgery, e.g., from an implanting surgeon or clinician, regarding the patient, the one or more implanted systems, such as a tooth number, an implant diameter, and information regarding healing collars, cover screws, and temporary abutments. As shown and described in detail below, the template module 44 may generate various fields for display on the user interface 42, e.g., a touchscreen, and the template module 44 may receive the input information corresponding to the dental implant surgery in the various fields displayed.

Upon receiving the user input information, the template module 44 may output the information to the report generation module 46 and, in particular, to the decision logic module 50. The decision logic module 50 may receive the user input information, e.g., a tooth number, implant diameter, etc., and query the database module 52 using the input information. For example, the decision logic module 50 may request from the database module 52 all implant diameters available for a particular tooth number selected by the user. The database module 52 may include, for example, a comprehensive database (relational, non-relational, flat file, etc.) of dental implant information.

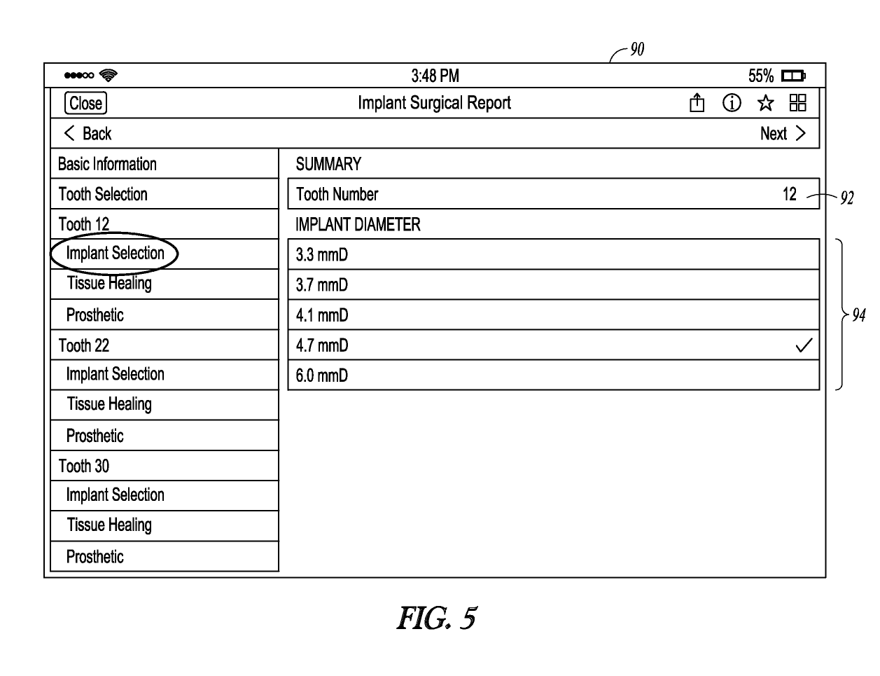

Based on the query by the decision logic module 50, the database module 52 may search its database for applicable information, e.g., implant diameter(s) associated with a particular tooth number, and return the information to the decision logic module 50. The decision logic module 50 may pass the returned information to the template module 44, which then causes the information to be populated, e.g., filled in, in one or more fields with the information. For example, as shown and described below with respect to FIG. 5, the template module 44 may display five (5) implant diameters from which the user may select the particular diameter used in the surgery.

The dental implant surgical reporting tool of this disclosure may generate a final report that may be sent to the restoration specialist once the user has finished inputting information for the one or more dental implants. More particularly, the template module 44 may receive user input indicating that the user has finished inputting information. In response, the template module 44 may request that the report generation module 46 generate a final report 54 for the dental restoration specialist. The report generation module 46 may assemble all the information input by the user into a format that may be saved, emailed, or printed.

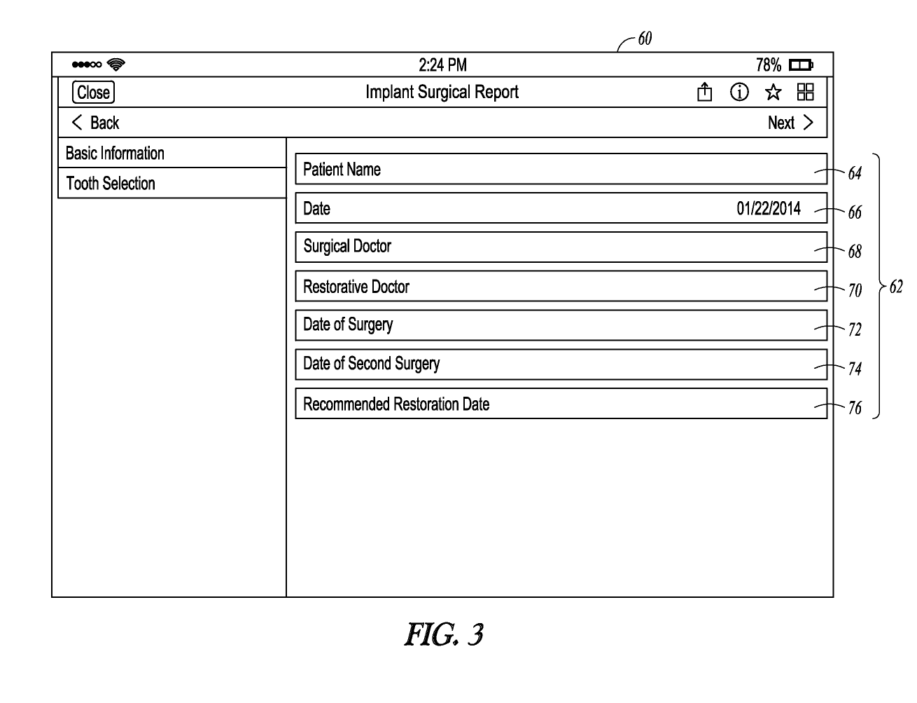

FIGS. 3-9 are screenshots of a dental implant surgical reporting template displayed on an electronic device having a display and a user interface, in accordance with this disclosure. As described in more detail below, the electronic device may display the template and receive, using the user interface, information corresponding to a dental implant surgery. The template may access a database, for example, to retrieve data using at least some of the received information, e.g., the applicable tooth. The electronic device may populate at least one field in the displayed template with the retrieved data, e.g., with one or more prosthetic abutments that may be used by the dental restoration specialist, and may generate a report for the dental restoration specialist that may include at least some of the received information and the retrieved data.

FIG. 3 is a screenshot 60 of an example portion of a template of the dental implant reporting tool. The screenshot 60 of FIG. 3 may include several input fields for receiving user input information, as shown generally at 62. The input fields may include, for example, a patient name field 64 for receiving the patient's name, a date field 66 for receiving the current date, a surgical doctor field 68 for receiving the name of the implant surgeon, a restorative doctor field 70 for receiving the name of the restoration specialist, e.g., dentist, that will perform the dental restoration procedure, a date of surgery field 72 for receiving the date of the implant surgery, a date of second surgery field 74 for receiving the date of a second implant surgery (if needed), and a recommended restoration date field 76 for receiving the date of the restoration surgery.

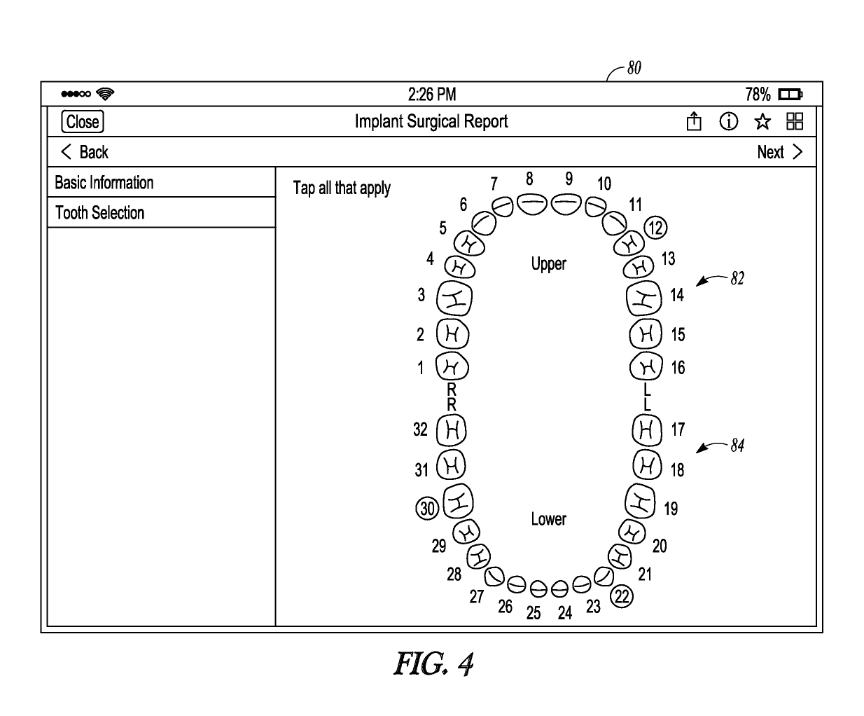

FIG. 4 is a screenshot 80 of another example portion of a template of the dental implant reporting tool. The screenshot 80 of FIG. 4 may include a display of one or more teeth. A user may then select from the one or more displayed teeth corresponding to the dental implant surgery. In an example, as shown in FIG. 4, the screenshot 80 of the template may display a graphical representation of one or more teeth, e.g., an upper set of teeth 82, a lower set of teeth 84, or both an upper set and a lower set of teeth, and a corresponding number of each respective tooth based on a dental notation system, e.g., the Universal Numbering System.

In some examples, the electronic device may include a touchscreen for receiving the user input information that includes a selection of the applicable tooth or teeth. In other examples, the electronic device may include a monitor and a computer mouse for receiving the user input information that includes a selection of the applicable tooth or teeth.

FIG. 5 is a screenshot 90 of another example portion of a template of the dental implant reporting tool. The screenshot 90 of FIG. 5 may display the number of a selected tooth (from the selection on screenshot 80 of FIG. 4) in a tooth number field 92, and an implant diameter input field, shown generally at 94, that allows a user to input information regarding the diameter of the implant used during the implant procedure.

The template module 44 receives the selected tooth information, e.g., a tooth number, from the user interface 42. The decision logic module 50 may receive the selected tooth information, e.g., a tooth number, and may query the database module 52 using the selected tooth information. The database module 52 may return one or more implant diameters to the decision logic module 50, which may determine which one(s) could be used to repair the selected tooth. For example, if an incisor was selected, the decision logic module 50 may determine that implant diameters used to repair a first molar, for example, are not applicable and, as such, should be excluded and not displayed. The decision logic module 50 may return the applicable implant diameter(s) to the template module 44, which displays the implant diameter(s) in the implant diameter input field 94 of the template. The user may select, using the user interface 42, the particular implant diameter used for the selected tooth.

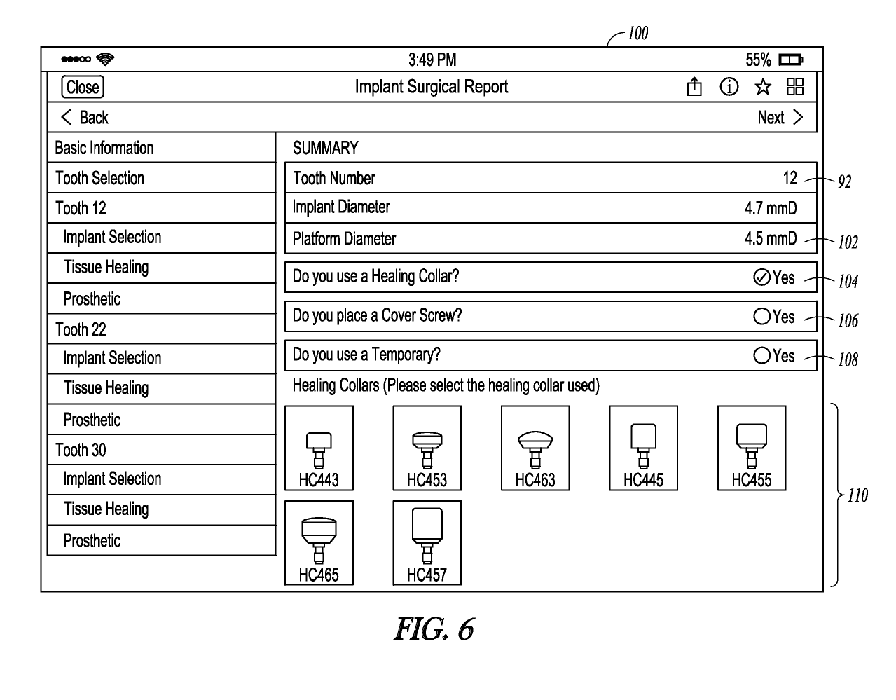

FIG. 6 is a screenshot 100 of another example portion of a template of the dental implant reporting tool. The screenshot 100 of FIG. 6 may display the selected tooth number (from FIG. 4), the implant diameter (from FIG. 5), and the platform diameter 102. In some examples, the platform diameter 102 may be automatically populated based on the implant diameter. The decision logic module 50 may determine which platform diameter is associated with the specified implant diameter, and the template module 44 may populate (e.g., automatically fill in) a field with the platform diameter 102 associated with the selected tooth number.

The screenshot in FIG. 6 may also display questions regarding whether the implanting surgeon used a healing collar at field 104, a cover screw at field 106, or a temporary abutment at field 108. If the user selects “YES” with respect to the healing collar at field 104, as seen in FIG. 6, the template module 44 receives the selection and outputs the selection to the decision logic module 50. The decision logic module 50 may query the database module 52 using the selected tooth information. The database module 52 may return one or more healing collars to the decision logic module 50, which may determine which one(s) could be used with the particular implant diameter and platform diameter of the selected tooth. In the example shown in FIG. 6, the decision logic module 50 determined that seven (7) healing collars are applicable, as shown generally at field 110. In some examples, the template module 44 may graphically depict the applicable healing collars, which may help the user confirm the selection.

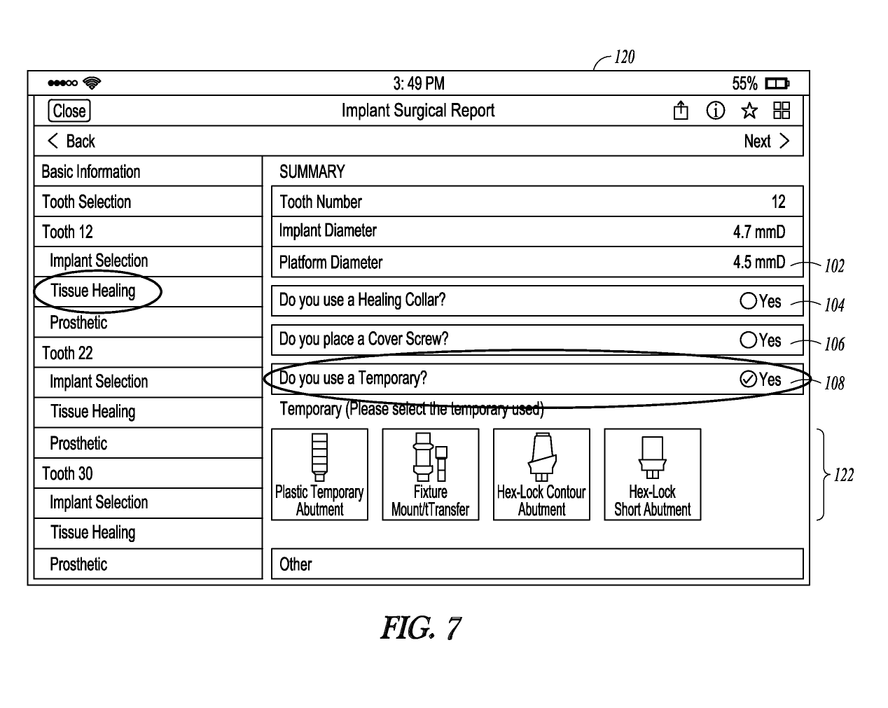

FIG. 7 is a screenshot 120 of another example portion of a template of the dental implant reporting tool. The screenshot 120 in FIG. 7 displays a question regarding a temporary abutment at field 108. If the user selects “YES” with respect to the temporary abutment at 108, as seen in FIG. 7, the template module 44 receives the selection and outputs the selection to the decision logic module 50. The decision logic module 50 may query the database module 52 using the selected tooth information. The database module 52 may return one or more temporary abutments to the decision logic module 50, which may determine which one(s) could be used with the particular implant diameter and platform diameter of the selected tooth. In the example shown in FIG. 7, the decision logic module 50 determined that four (4) temporary abutments are applicable, as shown generally at field 122. In some examples, the template module 44 may graphically depict the applicable temporary abutments, which may help the user confirm the selection.

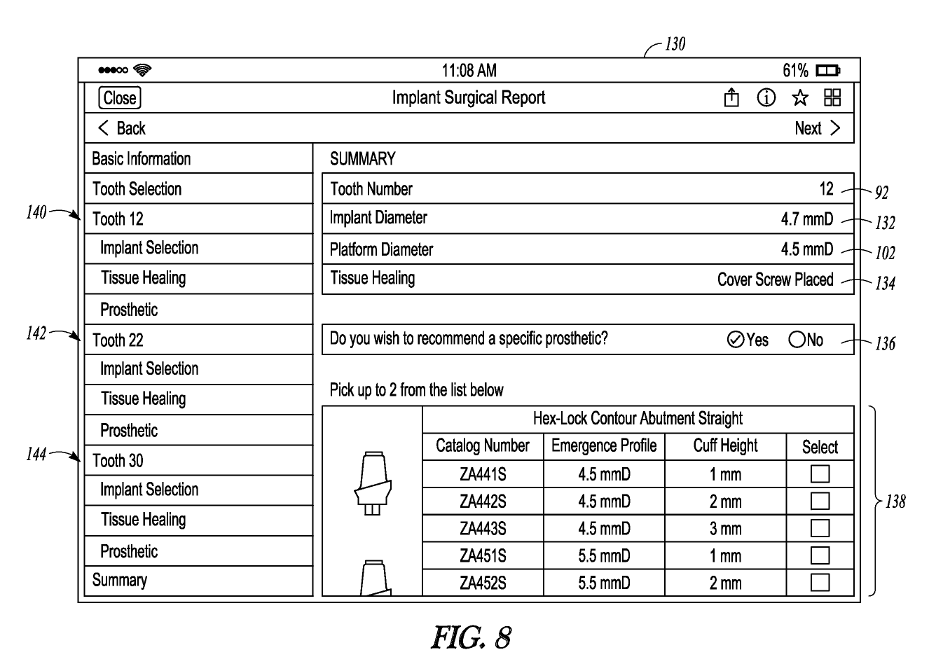

FIG. 8 is a screenshot 130 of another example portion of a template of the dental implant reporting tool. The screenshot 130 of FIG. 8 may display a summary of the selected tooth number 92, the selected implant diameter 132, the platform diameter 102, and the tissue healing 134, e.g., temporary abutment, healing collar, or cover screw.

In addition, the screenshot 130 may display fields that allow the user to input whether the user is including additional information, e.g., attaching information to a final report form generated by the reporting tool. For example, the screenshot may include (not depicted) a hex-lock restorative component field, a fixture mount transfer field, and a “none” field that indicates that the user is not providing additional information.

The screenshot 130 may also display a field 136 that allows a user to select whether to recommend a specific prosthetic to the restoration specialist. If the user selects “YES” with respect to the recommendation at field 136, as seen in FIG. 8, the template module 44 receives the selection and outputs the selection to the decision logic module 50. The decision logic module 50 may query the database module 52 using the information supplied by the user, e.g., the tooth number, the implant diameter, the platform diameter, and the like. The database module 52 may return one or more applicable prosthetics to the decision logic module 50, which may determine which one(s) could be used with the particular implant diameter and platform diameter of the selected tooth. In some examples, as seen in screenshot 130 at field 138, the template module 44 may graphically depict the applicable prosthetics for selection, which may help the user confirm the recommendation.

As mentioned above, the user may have selected more than one tooth, e.g., in FIG. 4. As such, the user may input information for each selected tooth. For example, screenshot 130 of FIG. 8 depicts that three (3) teeth were selected, as shown at fields 140, 142, and 144 (also shown in FIGS. 5-7). For each selected tooth, the user may input information regarding the implant diameter, etc. as described in detail above.

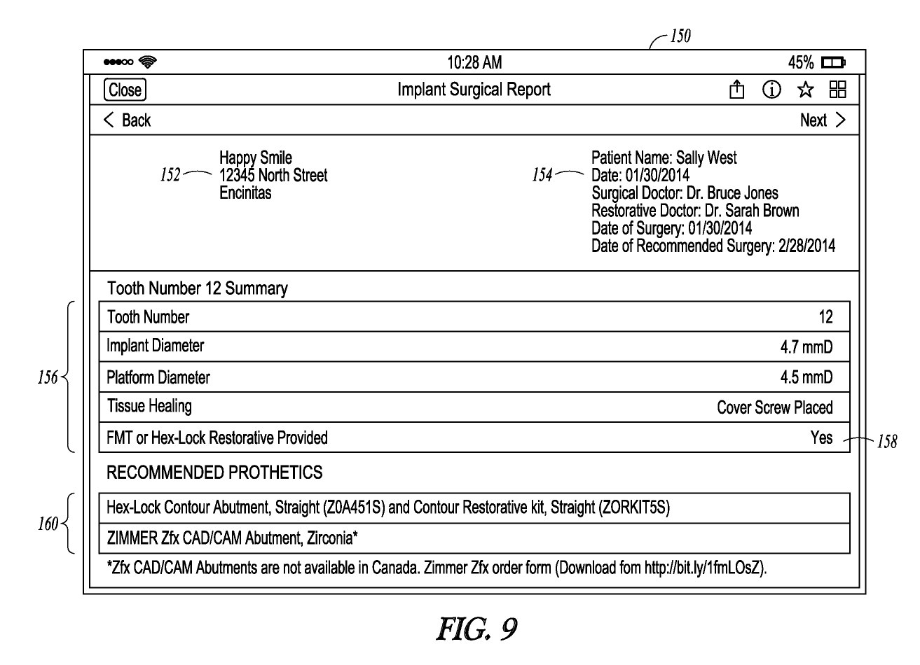

FIG. 9 is a screenshot 150 of another example portion of a template of the dental implant reporting tool. In particular, the screenshot 150 depicts an example of a final report form generated by the dental implant reporting tool of this disclosure, which may be given to the restoration specialist, e.g., emailed or printed.

The screenshot 150 may include an implanting surgeon contact information field 152, a patient/case information field 154, and a summary field 156 for the selected tooth. The summary field 156 may include information regarding tooth number, implant diameter, platform diameter, tissue healing, and whether additional information has been included regarding restorative components or fixture mount transfers, as seen at 158. Further, if the user has recommended one or more specific prosthetics, the recommended prosthetics are displayed at field 160. If the user selected more than one tooth, e.g., in FIG. 4, then the screenshot 150 of the final report form may depict summary information for the other teeth selected.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

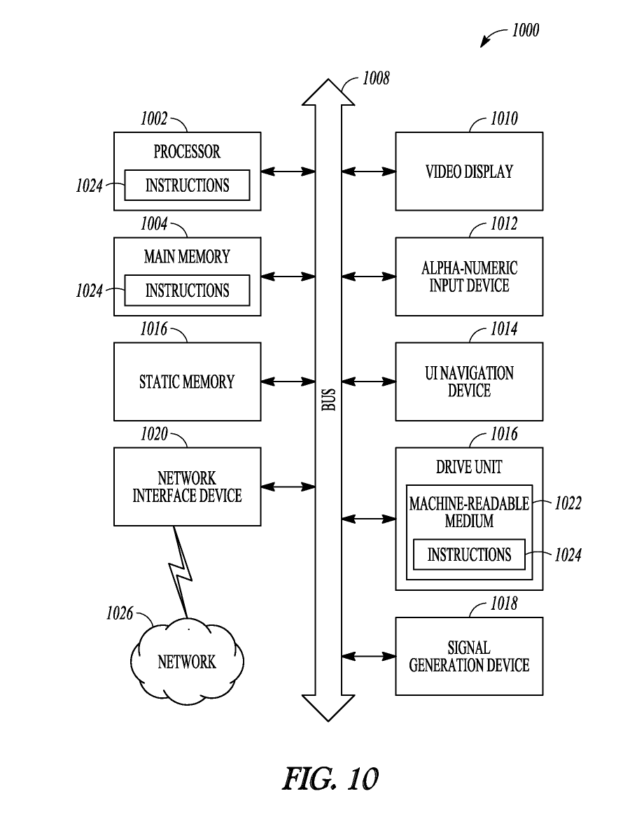

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices;

magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

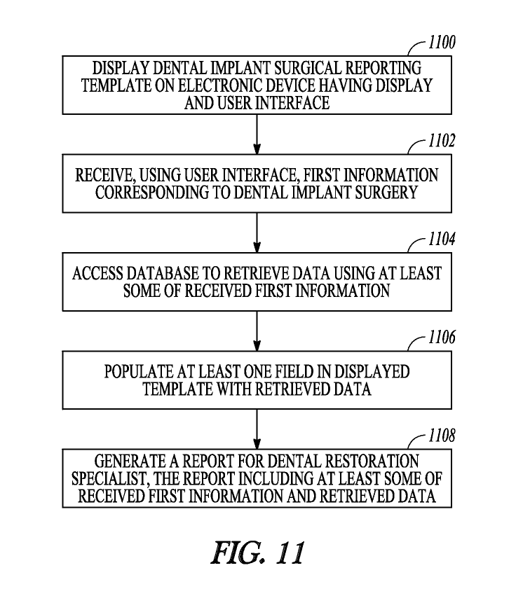

FIG. 11 is flow diagram of an example method of recording dental implant information, in accordance with this disclosure. The method may be performed using various components or modules as described in this disclosure. For example, the method may be performed by configuring one or more processors of a computing device.

In FIG. 11, a dental implant surgical reporting template is displayed on an electronic device having a display and a user interface (block 1100). The template may include one or more fillable fields.

At block 1102, the method may include receiving, using the user interface, first information corresponding to a dental implant surgery. In an example, the first information corresponding to a dental implant surgery may include a tooth number of the implant. In one example, the first information may include an implant diameter. In an example, the first information may include information regarding a cover screw.

At block 1104, the method may include accessing a database to retrieve data using at least some of the received first information. For example, the database may retrieve implant diameter data based on the tooth number. In an example, the retrieved data may include an appropriate platform diameter. In one example, the database is stored on the electronic device. In another example, the database is stored on a remote device.

At block 1106, the method may include populating at least one field in the displayed template with the retrieved data. For example, the template may populate one or more fields with the applicable implant diameter(s), platform diameters, etc. based on the received tooth number.

At block 1108, the method may include generating a report for a dental restoration specialist that includes at least some of the received first information and the retrieved data. For example, the report may include information that the user input, such as the tooth number, as information retrieved from the database, such as applicable implant diameter(s), platform diameters, and abutments.

The method of FIG. 11 may also include receiving, using the user interface, second information based on the retrieved data, where generating a report for a dental restoration specialist includes generating the report for the dental restoration specialist, the report including at least some of the received first information, the received second information, and the retrieved data. For example, the retrieved data may include a plurality of dental prosthetics, and the second information may include a user selection of one of the plurality of dental prosthetics.

The method of FIG. 11 may also include displaying a graphical representation of a set of teeth, where receiving, using the user interface, first information corresponding to a dental implant surgery includes receiving, using the user interface, a selection of one or more teeth in the set of teeth corresponding to a dental implant surgery.

In one example, the first information of the method of FIG. 11 may include information regarding a healing collar, and populating at least one field in the displayed template with the retrieved data may include displaying a plurality of types of healing collars.

In an example, the method of FIG. 11 may include receiving, using the user interface, at least one of a patient name, a surgical doctor name, a dental restoration specialist name, and a surgery date.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer implemented method of recording dental implant information, the method comprising:
displaying a dental implant surgical reporting template on an electronic device having a display and a user interface;
receiving, using the user interface, first information corresponding to a dental implant surgery;
accessing a database to retrieve data using at least some of the received first information;
populating at least one field in the displayed template with the retrieved data; and
generating a report for a dental restoration specialist, the report including at least some of the received first information and the retrieved data.

2. The computer implemented method of claim 1, wherein after populating the at least one field in the template with the retrieved data, the method comprising:
receiving, using the user interface, second information based on the retrieved data,
wherein generating a report for a dental restoration specialist includes:
generating the report for the dental restoration specialist, the report including at least some of the received first information, the received second information, and the retrieved data.

3. The computer implemented method of claim 2, wherein the retrieved data includes a plurality of dental prosthetics, and wherein the second information includes a user selection of one of the plurality of dental prosthetics.

4. The computer implemented method of claim 1, wherein displaying the dental implant surgical reporting template includes:
displaying a graphical representation of a set of teeth;
wherein receiving, using the user interface, first information corresponding to a dental implant surgery includes:
receiving, using the user interface, a selection of one or more teeth in the set of teeth corresponding to a dental implant surgery.

5. The computer implemented method of claim 1, wherein the first information includes an implant diameter.

6. The computer implemented method of claim 1, wherein the retrieved data includes a platform diameter.

7. The computer implemented method of claim 1, wherein the first information includes information regarding a healing collar, and wherein populating at least one field in the displayed template with the retrieved data includes displaying a plurality of types of healing collars.

8. The computer implemented method of claim 1, wherein the first information includes information regarding a cover screw.

9. The computer implemented method of claim 1, wherein the database is stored on the electronic device.

10. The computer implemented method of claim 1, comprising:
receiving, using the user interface, at least one of a patient name, a surgical doctor name, a dental restoration specialist name, and a surgery date.

11. A machine-readable medium including instructions for recording dental implant information, which when executed by a processor, cause the processor to perform operations comprising:
displaying a dental implant surgical reporting template on an electronic device having a display and a user interface;
receiving, using the user interface, first information corresponding to a dental implant surgery;
accessing a database to retrieve data using at least some of the received first information;
populating at least one field in the displayed template with the retrieved data; and
generating a report for a dental restoration specialist, the report including at least some of the received first information and the retrieved data.

12. The machine-readable medium of claim 11, wherein after populating the at least one field in the template with the retrieved data, the operations comprising:
receiving, using the user interface, second information based on the retrieved data,
wherein generating a report for a dental restoration specialist includes:
generating the report for the dental restoration specialist, the report including at least some of the received first information, the received second information, and the retrieved data.

13. The machine-readable medium of claim 12, wherein the retrieved data includes a plurality of dental prosthetics, and wherein the second information includes a user selection of one of the plurality of dental prosthetics.

14. The machine-readable medium of claim 11, wherein displaying the dental implant surgical reporting template includes:
displaying a graphical representation of a set of teeth;
wherein receiving, using the user interface, first information corresponding to a dental implant surgery includes:
receiving, using the user interface, a selection of one or more teeth in the set of teeth corresponding to a dental implant surgery.

15. The machine-readable medium of claim 11, wherein the first information includes an implant diameter.

16. The machine-readable medium of claim 11, wherein the retrieved data includes a platform diameter.

17. The machine-readable medium of claim 11, wherein the first information includes information regarding a healing collar, and wherein populating at least one field in the displayed template with the retrieved data includes displaying a plurality of types of healing collars.

18. The machine-readable medium of claim 11, wherein the first information includes information regarding a cover screw.

19. The machine-readable medium of claim 11, wherein the database is stored on the electronic device.

20. The machine-readable medium of claim 11, the operations comprising:
receiving, using the user interface, at least one of a patient name, a surgical doctor name, a dental restoration specialist name, and a surgery date.
